(19) United States
(12) Patent Application Publication
(10) Pub. No.: US 2012/0207960 A1
(43) Pub. Date: Aug. 16, 2012

(54) DECORATED MAGNETIC SUBSTRATE

(75) Inventor: JOHN E. FINGER, Milford, OH (US)

(73) Assignee: General Data Company, Inc., Cincinnati, OH (US)

(21) Appl. No.: 13/396,667

(22) Filed: Feb. 15, 2012

Related U.S. Application Data
(60) Provisional application No. 61/442,905, filed on Feb. 15, 2011.

(51) Int. Cl. B32B 3/06; B44C 1/17; B32B 33/00; B32B 3/26; B32B 7/12

(52) U.S. Cl. 428/41.8; 428/66.4; 428/66.5; 428/195.1; 156/240

(57) ABSTRACT

A disc having application in a bottom up beverage cup filling process for lifting to receive a beverage through a cup hole and for sealing the hole after filling. A composite laminate includes FDA recognized films, inks and adhesives, and including either a magnet substrate or a flexible magnetic receptive coating for attachment to a substrate. Various constructions, methods and applications are disclosed.

### PRIORITY CLAIM

Applicant claims the benefit of the filing date of Feb. 15, 2011 of U.S. provisional patent application Ser. No. 61/442,905, the disclosure of which is hereby incorporated herein by reference in its entirety.

### FIELD OF THE INVENTION

This invention relates to the provision of media, including words, graphics, logos, trademarks, designs and the like on substrates, more particularly onto magnetically responsive or operational substrates, and even more particularly onto magnetic substrates immersed in use in beverages for human consumption.

### BACKGROUND OF THE INVENTION

In a relatively new innovation in the field of beverage dispensing and more particularly beer dispensing, it is proposed to provide a cup with a hole in the bottom surrounded by a magnetically responsive ring such as a ferrite-containing material or other magnetically attractable materials. A preferably slightly flexible magnetic material in disc form magnetically attracts the disc to the ring and sealingly sticks the disc, sealing the hole.

Upon filling, the cup is pushed down over a beer-dispensing nozzle which unseats the disc from the ring. Beer is dispensed around the disc edges into the bottom of the cup, filling the cup with beer from the bottom up, and in doing so provides a fuller cup, with less foam “head”, much more quickly than filling the cup with beer from the top.

Once removed from the nozzle, the magnetic disc reseats on the ring, sealing the hole, and allowing the cup to hold the beer for drinking.

This bottom-up fill provides filling the cup with beer in a matter of a few seconds, only, and accelerates the dispensing of beer at an event of high volume attendance where the customer's wait in line for a beer is thus substantially reduced, A description of the apparatus and process, together with customers' interview, can be found on the world wide web in several websites including the word “GRINON”.

Also, the process and related structure is described in pending U.S. patent application Ser. No. 12/992,881 published on Mar. 17, 2011 under Publication No. US2011/0061764 and pending U.S. patent application Ser. No. 13/008,786 published on May 26, 2011 under Publication No. US2011/0121020, both applications and both Publications are herein expressly incorporated by reference.

It is to the laminated or composite magnetic disc noted above that this present invention is directed.

It is to be appreciated that such a disc provides two surfaces on which advertising, promotions, games, information or other visual indicia can be placed.

In use, one side of the disc faces upwardly, the top side, into the cup where it can be visualized by the drinker. The other side faces downwardly, the bottom side, against the ring and over the hole in the cup bottom.

Since the upwardly facing or top side is within the beer in the cup, it cannot comprise any indicia or material which is not fit for contact with the beverage for human consumption. Accordingly, any indicia or structure on that side must be of materials approved for such contact by the U.S. Food and Drug Administration (FDA). It is also desirable that materials used in any indicia on the bottom side be similarly approved as it may be desirable in some instances to flip the disc.

Thus, one consideration for the provision of indicia to the disc is the necessity of FDA approval for the indicia or other structure such as covers, liners or protective layers. The application of indicia to the disc is thus problematical from this standpoint.

Another difficulty in applying indicia to the disc lies in the magnetic parameters of the disc. Such magnetic substrates now available come in several varieties, including material magnetized on one side, or material magnetized on two sides. When the material is magnetized on two sides, i.e. opposite faces of the disc, the magnetic performance of either side is automatically reduced to about 60% of its capacity because of the magnetic properties on the other side. As a result, the magnetic attraction of a two-sided magnetized disc to the sealing ring about the hole in the cup bottom is reduced, and the magnetically-generated seal is weaker than it would otherwise be if only one side of the disc material is magnetized. Accordingly, any indicia on the sides of the disc should not also include liners, layers or substrates from the indicia process which would also further interfere or weaken the magnetically-generated seal. Thus, the structure of the disc and the indicia process is limited by both FDA regulation as well as the magnetic or sealing performance of the disc to the ring around the hole in the cup bottom.

When the indicia is desired to be printed, currently known printing techniques are thus contra-indicated, particularly where all media material must be FDA approved.

Thus, in using a disc with both sides magnetized and both sides bearing indicia, appropriate FDA compliance must be accomplished but with an indicia or printing process or system which does not adversely weaken the magnetic attraction of the disc to the ring and thus seal performance.

Accordingly, it has been one objective of the invention to provide a cup bottom, hole-sealing disc bearing indicia on both sides and effectively sealing a hole in the bottom of a beverage cup.

A further objective of the invention has been to provide indicia on a beverage submersible member in compliance with FDA regulations.

A further objective of the invention has been to provide a hole sealing disc for a bottom up filling process with indicia thereon in a manner consistent with FDA regulations.

A further objective of the invention has been to provide an improved process for manufacturing a magnetic disc with indicia thereon and for use in a bottom up filling process.

A further objective of the invention has been to provide an improved indicia applying process and apparatus for a variety of magnetic or other substrates.

### SUMMARY OF THE INVENTION

To these ends, a preferred embodiment of the invention includes a magnetic disc having top and bottom sides, both preferably magnetized, and a printed indicia on at least one side thereon, including at least an FDA-compliant ink and an FDA-compliant adhesive holding the ink on the one side. This disc embodiment is provided by a preferably four-color printing apparatus and process comprising a carrier web, a release coating, a reverse printed indicia carried thereby and an adhesive layer. In use, this composite is passed through an apparatus which applies the composite to a magnetic disc substrate, removes the carrier web and die-cuts a disc with the indicia thereon into the final disc shape. Indicia can be applied to the other side of the disc in the same way, that carrier removed, and the two-sided disc die cut with indicia on each side.

Such apparatus and process produces a disc with indicia thereon, but with no carrier or other film or thick layer on the disc as would interfere with the magnetic attraction between the disc and the ring surrounding the hole.

In other applications wherein indicia bearing magnetic substrates are used, the indicia may be coated with scuff-resistant, UV light-resistant or other coatings after application to the substrate or earlier in the process as or before the reverse print ink is deposited on the carrier web, release coat or the like.

Moreover, additional embodiments of the invention provide a variety of different laminate constructions, including other scratch-off constructions; coupons with hidden indicia; tactile surfaces; various magnetic components and lenticular components.

These and other benefits and advantages will be readily apparent from the following written description and from the drawings wherein:

### BRIEF DESCRIPTION OF THE DRAWINGS

FIG. 1 is a graphic illustration of a preferred laminate for use on a base;

FIG. 2 is a graphic illustration of an alternate laminate as in FIG. 1, but illustrating a clear film as a carrier to remain with the final product;

FIG. 3 is a graphic illustration of an alternate laminate to FIG. 1 but showing the addition of variable images to the print indicia;

FIG. 4 is a graphic illustration of an alternate laminate as in FIG, 3 but showing the addition of a scratch-off patch;

FIG. 5 is a graphic illustration of an alternate laminate to FIG. 2 but illustrating the use of a thermo chromatic (color change with temperature change) ink to remain with the final product; this ink will change color when exposed to different temperatures. These inks can be made capable of going from non-visible at room temperature to a visible color at a cold temperature and can be specifically formulated to provide the desired color within a given temperature range;

FIG. 6 illustrates an alternative embodiment of the invention illustrating use of a clear over laminate and an opaque base film;

FIG. 7 illustrates another alternative embodiment of the invention including a scratch-off component or coupon component bearing hidden information;

FIG. 8 illustrates another alternative embodiment of the invention including an embossed or tactile surface;

FIG. 9 illustrates an embodiment of the invention utilizing a flexible magnet receptive coating on a base film bearing indicia;

FIG. 9A illustrates an embodiment of the invention as in FIG. 9 but without a base film;

FIG. 10 illustrates an embodiment of the invention utilizing a lenticular construction using a lens layer to visually enhance or enlarge indicia on a magnetic base; and

FIG. 11 illustrates an embodiment as in FIG. 10 but utilizing a flexible magnetic coating.

In all the figures, the illustration is of the components of an embodiment of the disc invention in exploded or expanded format. In final construction, the layers shown are juxtaposed together.

### DETAILED DESCRIPTION OF THE INVENTION

Turning now to a more detailed description of the invention, the figures are representative of a construction that allows multicolor print to be applied to a flexible magnet material or other substrate. The substrate could then be cut into patterns suitable for the end use.

This material is constructed preferably using flexographic printing due to the low cost, high yield and accuracy of the process. Color combinations, ink type and number of layers are virtually unlimited. In some cases, the product must have the ability to be utilized in a manner that would remain in compliance with FDA requirements for direct or indirect food contact. In these instances, the inks, coatings and adhesives would be manufactured in compliance with those regulations.

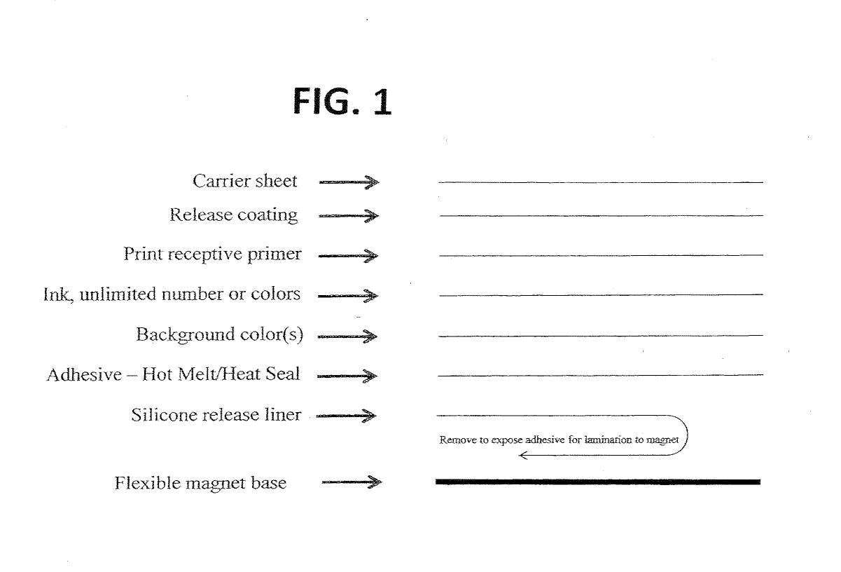

FIG. 1 depicts a preferred construction according to the invention which includes, in the order shown, a carrier sheet or web, release coating thereon, a print receptive primer, indicia comprising ink in one or more colors and preferably in a four color application, a background color, an adhesive coating which may comprise a hot melt or a heat seal material and a removable release liner such as a silicon liner.

This construction is applied preferably to a side of a flexible magnetic base or substrate after removal of the silicon release liner to expose the adhesive to the substrate. Thereafter, the carrier sheet or web is removed and the remaining layers die cut in a disc or other desired pattern along with the disc.

As seen in FIG. 1, the base layer or “carrier sheet” material would typically be a smooth, clear, untreated polymer-based material, i.e. polypropylene, polyester, polystyrene, polyethylene or between 0.0005 and 0.003 inches in thickness, however, smooth paper materials or white film could also be utilized with no aversion in performance. The construction would be adhered to the opposing substrate by removing the release liner, thus exposing the adhesive and pressure laminating the composite to the opposing substrate. After the bond is achieved, the “carrier” would be stripped away, leaving the inks and adhesive bound permanently to the surface of the opposing substrate, and the entire laminate die-cut.

It will be appreciated that many materials could be used in the combination noted. Examples of useful materials are noted below without limitation.

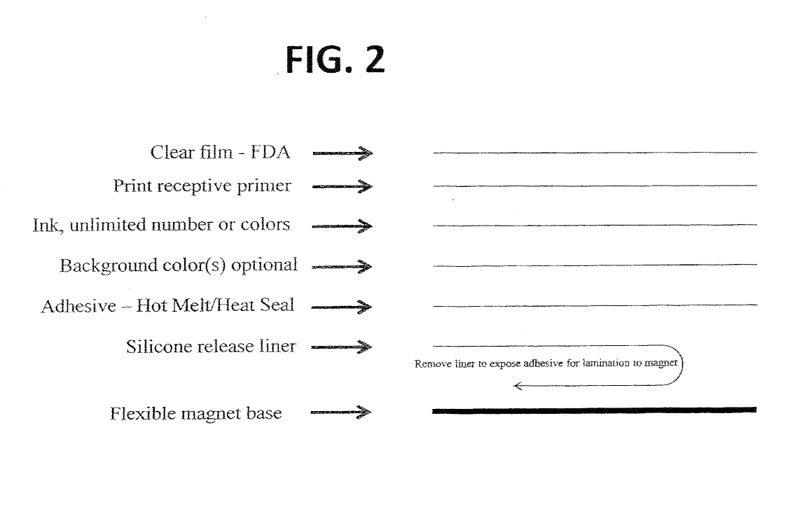

In an alternative illustration in FIG. 2, the inks will be applied to an FDA compliant clear substrate or film for the specific use. Otherwise, the materials in the laminate are as noted with respect to FIG. 1. In this embodiment, the carrier sheet is clear to facilitate the viewing of the ink after the film composite has been adhered to the magnetic base material. In this application, the carrier film will not be removed after the composite is bonded. These applications would be preferred where the end use product would be subjected to a more harsh environment such as abrasion, thus the images would remain without degradation during the use of the product.

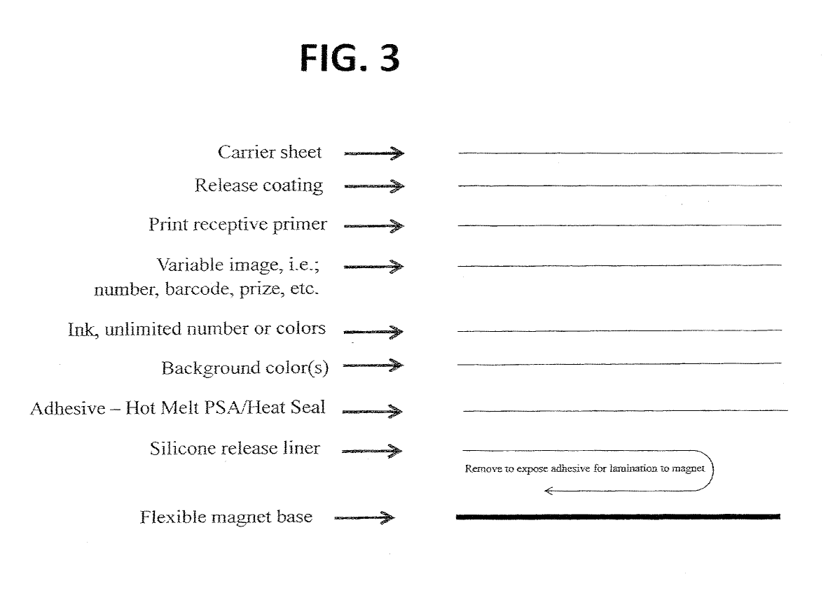

The alternative illustrated in FIG. 3 is similar to that of FIGS. 1 and 2 but with addition of a variable imprinted indicia such as a number or code or graphic which can be varied and in any desired location. The variable indicia can be comprised of the inks noted above.

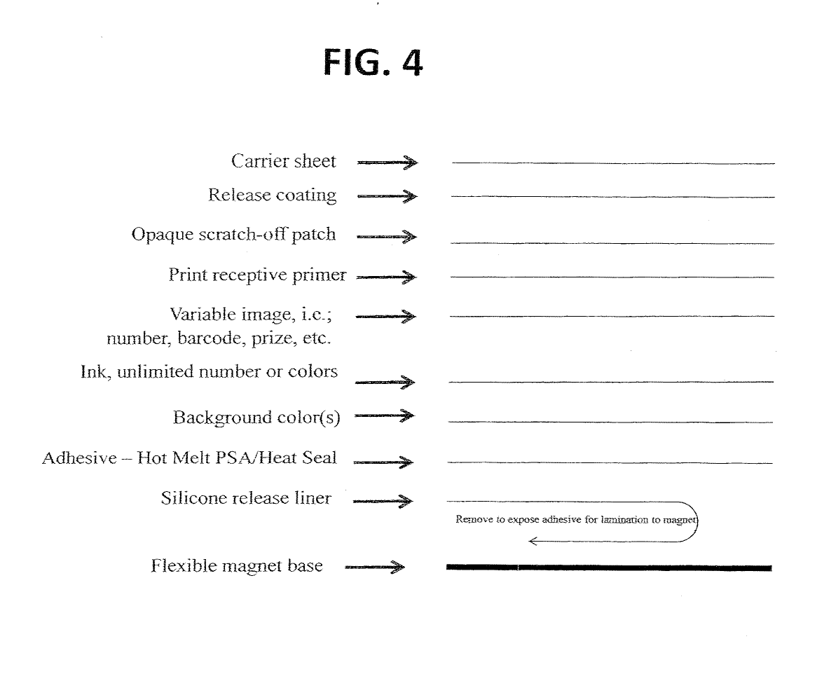

The alternative shown in FIG. 4 is similar to FIG. 3 but with the further addition of a “scratch-off” patch. An opaque “scratch-off” patch, together with the application of the variable number or image printed in the same area of the material, provides a further function. This would provide the number or image to be concealed until the user abraded the scratch-off patch to reveal the concealed image such as is utilized in some instant lottery type applications. In this embodiment, the scratch-off patch is made from materials comprising waxes and opaque additives to prevent the underlying image from being visible until the wax/pigment layer is “scratched off” revealing the hidden message. This type construction is frequently utilized in instantly redeemable lottery tickets.

Such a “scratch-off” patch is known in the industry, although where in use in contact with any food or beverage for human consumption, would be manufactured from materials in compliance with FDA regulations.

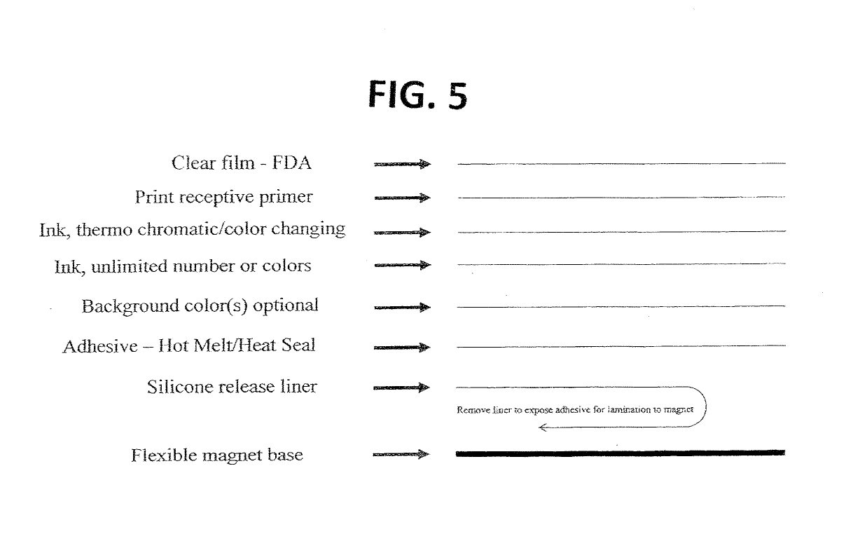

Finally, the alternate embodiment illustrated in FIG. 5 includes at least ink which is thermo chromatic or color changing in response to temperature. As illustrated in FIG. 5, such ink is deposited with (or without) other inks in the laminate and on the print reception primer as illustrated in FIG. 5.

As noted above, the thermo chromatic ink is capable, for example, of changing from being non-visible at room temperature to a visible color at a colder temperature. The ink can be formulated to provide a desired color within a given temperature range.

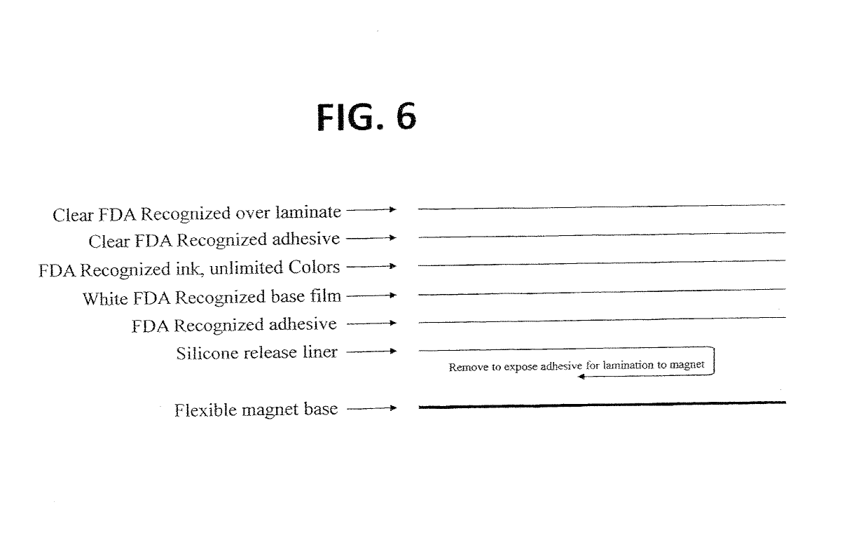

Turning now to further alternative embodiments of the invention, and referring to FIGS. 6-10A, it will be appreciated that the following embodiments are consistent with the foregoing objectives and advantages, but differ somewhat in the particular configuration of the layers or laminate components as will be described. The following embodiments utilize the same or similar materials as noted above, for the same components, or other suitable materials therefor as will be appreciated consistent with the invention and descriptions thereof.

In these embodiments, as well as in those of FIGS. 1-5, it will be appreciated that FIGS. 6-10A are graphic representations of the disc structures and particularly the layers thereof with lines graphically illustrating the layers or laminates of the particular disc embodiments in exploded or expanded format for clarity. While each line of the layer on the base is of equal thickness, for clarity, the individual layers can be of somewhat different thicknesses as noted above or as desired.

It will also be appreciated that in all embodiments, as shown in FIGS. 1-10A, the final form of the discs produced is preferably, but not necessarily, of round shape once the laminate structures are die-cut and applied to the magnetic base member as shown in the FIGS.

Turning now to a preferred embodiment as shown in FIG. 6, the disc includes an over laminate, preferably clear of polypropylene and a base film, also of polypropylene, preferably which I color or of another opaque color. Inked indicia is printed onto the white base film, the over laminate film applied thereover, adhesive applied to the underside of the white base film, and a release liner applied. The release liner can be stripped to adhere the composite so formed to a magnetic base. Alternately, the adhesive and liner omitted so the magnet manufacturer can apply adhesive to laminate the composite to the magnet. Of course, the over laminate is optional as well.

The noted adhesives can be pressure sensitive or heat sealable (activated) to provide a permanent bond of the composite to the magnetic material.

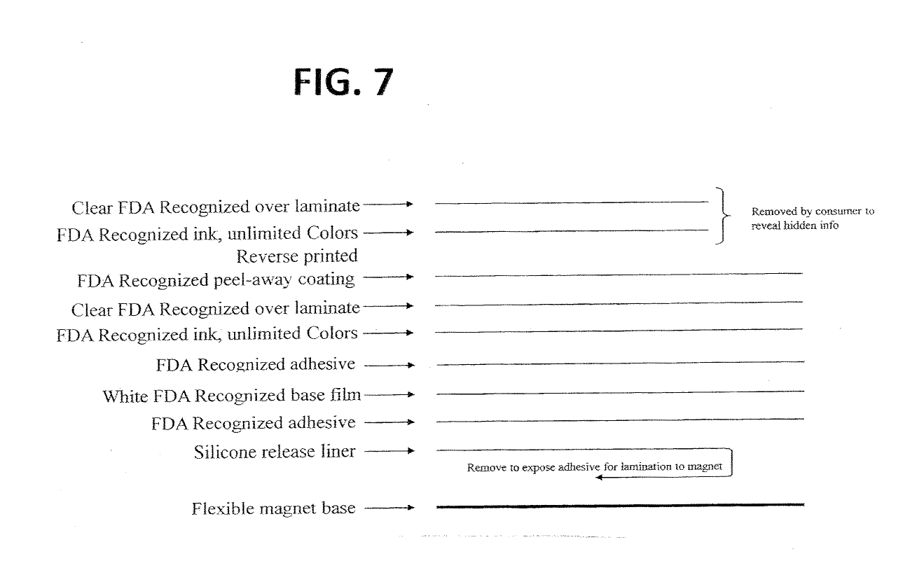

Another embodiment is illustrated graphically in FIG. 7, providing for adding hidden indicia by way of a peel-away coupon or scratch-off section. The hidden indicia may comprise serial numbers, prize information, discount coupons or other information. Accordingly, and while somewhat similar to the foregoing embodiment of FIG. 6, this embodiment further includes a second over laminate layer adhered to the base film and protecting indicia on the base film once the scratch-off or coupon layer is removed by a consumer upon finishing the beer in the cup.

Accordingly, ink indicia is applied or reverse printed to the first clear over laminate, a peel-away or scratch-off member is applied, a second clear over laminate receives other ink indicia and an opaque or white base film is adhesively applied to the second clear over laminate and a removable release liner is applied to facilitate, after removal, application to a preferably flexible magnet base.

The composite is applied to the magnetic base by peeling the release liner away or by applying adhesive where no adhesive or release was first applied. The composite and magnet are then die cut to final shape.

A consumer can remove the upper over laminate to reveal a scratch-off layer or a removable coupon layer. The additional clear over laminate reveals the printed ink indicia thereunder.

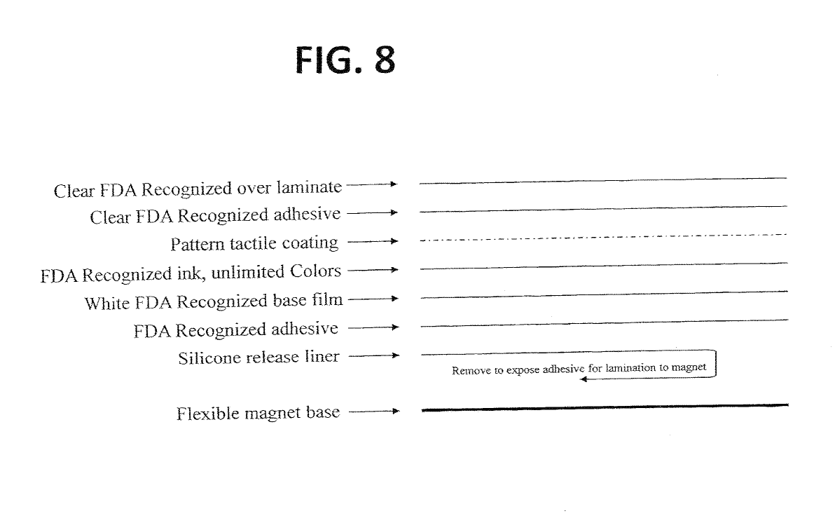

Turning now to FIG. 8, surface embossing of the imaged film can provide another novelty feature. The use of tactile coatings added to the printed surface provide raised areas to give the appearance and feel of embossing without actually mechanically embossing the material. Mechanical embossing would render the reverse side of the magnet uneven and result in potential leaks of the beverage in the cup or container.

Thus, in the embodiment of FIG. 8, a patterned tactile coating is applied as shown in FIG. 8 to the construction as shown in FIG. 6 to provide the low profile necessary for appearance and feel of embossing without actually mechanically embossing the material and without resulting in leaks if the disc is reversed. Otherwise, this embodiment is like that of FIG. 6.

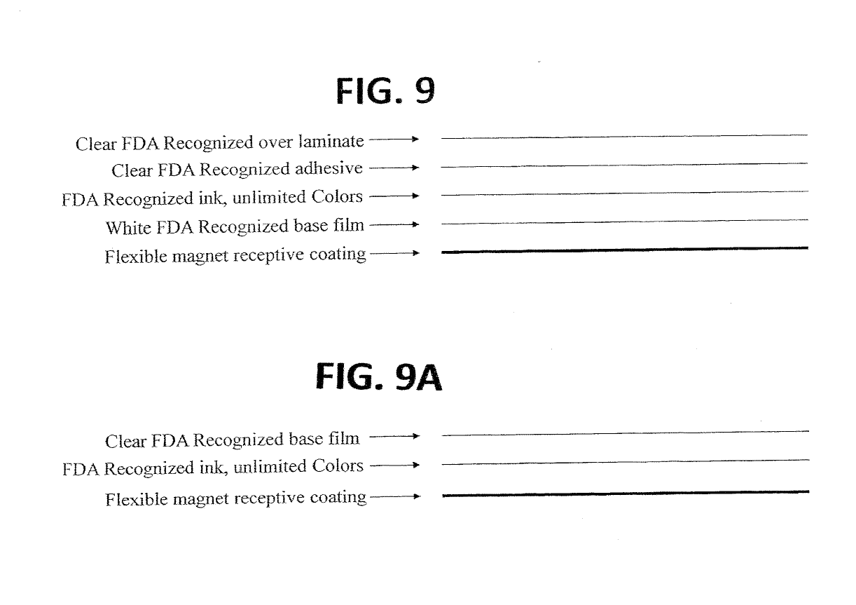

In FIGS. 9 and 9A, different composite or laminate structures are contemplated. In FIG. 9, the structure is similar to that of FIG. 6, however, a flexible magnetic receptive coating is applied to the white base film, and the composite is adhered to the ring in the cup by a magnetic attraction of this coating without use of a separate flexible magnet base.

Presently, magnetic media for such a coating is provided by Magnun Magnetics of Marietta, Ohio, further described at www.magnummagnetics.com.

The magnetic media could be manufactured by other magnetic material suppliers and in different formats. One process is the use of an extrusion process that utilizes ferrite particles embedded into a meltable material that is extruded directly onto the unprinted surface of the print media. The percentage of ferrous loading is between 50 and 90%. The extrudate would be applied to the film at between 0.005 and 0.030 in thickness. This format would eliminate the need for: A) an adhesive to bond the printed media to the magnetic media; B) secondary processing, as this step could be accomplished during the printing process; C) need for extremely expensive processing equipment requiring multiple steps; D) delays associated with scheduling; and E) cost associated with shipping the printed media to the magnet supplier.

The ferrite particles could be either bare or encapsulated and be dispersed into an FDA recognized conveyant (such as natural rubber, EVA, PVA or PVDC) facilitating extrusion and anchorage to the printed substrate. See U.S. Pat. No. 6,790,378 incorporated herein by reference. Magnetic charge would be applied at the time of manufacture or at some subsequent point prior to installation into the beverage receptor. As used herein, the phrase “flexible magnet receptive coating” preferably means a coating which is itself magnetized or alternately which is capable of being magnetically attracted.

FIG. 9 illustrates the use of a composite with only a base film, ink thereon and a magnet receptive coating applied directly over the ink indicia on the base film, without any additional adhesive layer.

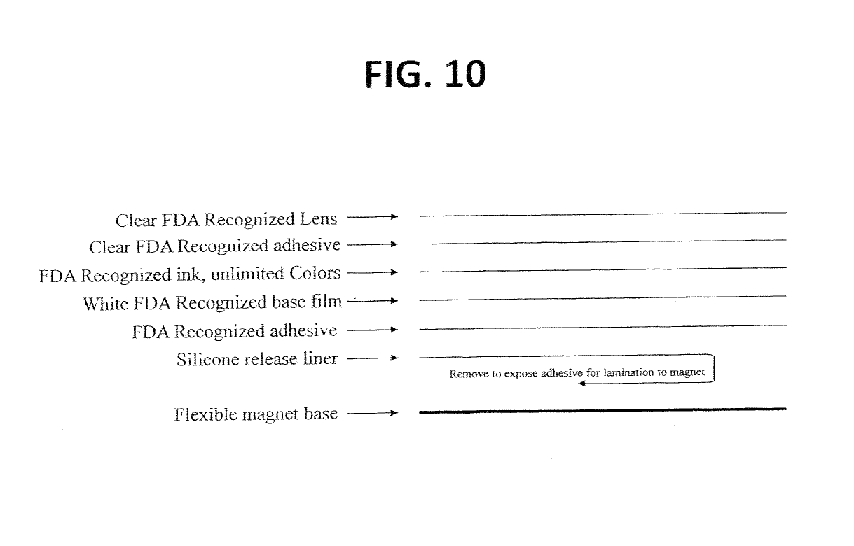

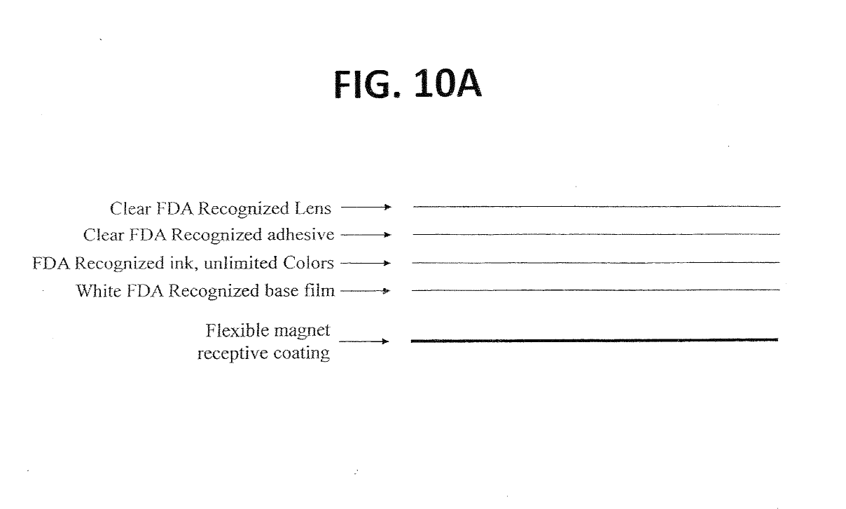

Finally, FIGS. 10 and 10A illustrate embodiments of the invention utilizing a lenticular feature in place of an over laminate.

A lenticular graphic construction provides the ability to show more than a single (or an enlarged) graphic on one surface, allowing the advertiser to use the same amount of space but have multiple images which are optically separated or 3 dimensional images using a refracting lens of between 0.003 and 0.03 inches thick, for example. The printing process would provide the graphic quality to allow the visual alterations necessary to be visible through the lenticular lens. See http://en.wikipedia.org/wiki/lenticular printing, expressly incorporate herein by reference, for example. Lenticular elements of any suitable form may be used.

In FIG. 10, a lenticular element is used in a disc structure like that of FIG. 6, excepting the substitution of a lenticular element for an over laminate. Otherwise, the disc is like that of FIG. 6 but with the added function of the lenticular element, enhancing the appearance of the ink indicia.

FIG. 10A illustrates a modification to the disc of FIG. 10 where a flexible magnet coating is used, as in FIG. 9 or 9A, in place of the adhesive, release liner and magnet base of FIG. 10.

Accordingly, the invention, in a variety of embodiments, provides enhanced constructions of the sealing disc for a bottoms-up cup, providing effective sealing, enhanced and less expensive laminate disc construction and substantially improved indicia application and promotional capacity.

It should also be appreciated that other print processes can be used within the scope of the invention. For example, printing can be digital (i.e. ink jet and laser, flexographic and offset printed for the application.

Composite media can be provided in rolls or sheets for lamination to the magnet material. Preferably, the materials of the composite are all assembled and, where a magnet substrate is used, then all the composite components and that substrate are die cut to final shape.

Digital printing provides the ability to make each individual magnet to be high quality colored print different in some way, such as a graphic image, photo, picture, number, barcode, etc., providing the customer with the ability to incorporate options into the magnet for prize distribution or promotional advantages.

While the price is typically some increment higher, the versatility of unique items provides a very impressive marketing opportunity.

Offset printing provides high quality graphics, typically static information, less expensive than digital, more expensive than flexographic and typically provided in sheeted format, and can be used in appropriate conditions as desired.

Flexographic printing processes can also be used, still providing the most economical way to provide color static graphics and yet can be printed with variable images in one or more colors, either in the same process or post the flexographic process using a digital printer.

In the foregoing embodiments, the components noted may include, but are not limited to the following materials and sources therefor, including but not limited to:

CARRIER SHEET: Polyester is available in grades suitable for direct food contact in clear, matte clear, and colors. Sources include E.I. DuPont De Nemours (Mylar®); SKC Inc. (Skyrol®) of Covington, Ga.; and DuPont Teijin Films (Mylar®) of Chester, Va.

Polypropylene is available in clear, matte clear, white, matte white with or without surface treatment for various applications. Sources include: Nan Ya Plastics Corp. USA of Livingston, N.J. (“FB”, “FF”, “FV” series for food packaging); and Multi-Plastics Extrusions, Inc. of Lewis Center, Ohio (5020 grade).

Polystyrene FDA approved for direct and indirect food contact depending on grades, high clarity. Sources include: Transilwrap Company, Inc. of Strongsville, Ohio (Oriented polystyrene, Clear); and Multi-Plastics Extrusions, Inc. of Lewis Center, Ohio (Oriented polystyrene—MPX grade).

INKS AND COATINGS: Such inks and release coatings are obtainable from: American Water Graphics of Forest City, N.C. (FDA varnishes for indirect or direct food contact, flexographic inks); and Actega WIT of Lincolnton, N.C. (FDA varnishes for indirect or direct food contact, flexographic inks, heat seal adhesive).

ADHESIVES: Suitable adhesives are obtainable from Dyna-Tech Adhesives of Grafton, W. Va. (including Direct food contact adhesives (aqueous, hot melt, heat seal adhesive)).

RELEASE LINER: Release liner materials include: paper or plastic film, either preferably coated with a silicone release agent in order to promote the removal of the coatings and inks intact after lamination to the magnetic base material. Such liner materials are available, for example, from PentaTech Coated Products, LLC of Macedon, N.Y. and SilTech , SKC of Miamisburg, Ohio.

MAGNETIC BASE SUBSTRATES: Such substrates include ferrous metal encapsulated with polymers and binders, extruded into a flat sheet in a thickness suitable to hold a magnetic imprint for the desired use and are available from Magnum Magnetics Corporation of Marietta, Ohio; Master Magnetics, Inc. of Castle Rock, Colo. and Rochester Magnet Company of East Rochester, N.Y.

The use of this apparatus and process as described above provides for achieving a four-color or multiple color transfer process useful in many applications, and particularly in a food or beverage contact environment, where the provision of a multiple-color indicia in full FDA compliance, is provided. The invention may also find use for applications where the base material is non-magnetic.

The use of other coatings can enable yet further constructions to provide specified environmental resistance, provide a slippery surface, provide grip, or be scratch resistance and the like.

For example, there are other potential uses for products with this design in that this invention enables the ability to transfer the printed image to other surfaces that cannot be printed without the use of specifically designed equipment, i.e. stiff sheeting such as wood, plastic panels, glass, metal (of which flexible magnet may be included) or where the intended material is of small quantity and thus makes directly printing on the material impractical. Surfaces that may have irregular shape such as cylinders, tubes, or cones may benefit from the ability to transfer a printed image instead of requiring unique tooling to apply the image directly to the surface. Should printing be desired on materials of high value this invention would reduce the waste associated with direct printing and provide an economical method of applying graphics or text to these items.

Also, application of graphics or the like onto embossed surfaces can be accommodated. This invention provides transfer of the image to the surface, then the surface is embossed without increase in thickness or direct surface modification.

Finally, the discs so provided by the invention are particularly useful in the bottoms-up filling process to seal the holes in the cup bottoms, allow bottoms up filling, retain beer in the cups until depleted, and function as a promotional carrier or display during and after consumption of the beverage, while complying with FDA regulations and eliminating more expensive and complex printing and constructions.

These and other modifications and advantages will become readily apparent to those of ordinary skill in the art to which this invention pertains, without departing from the scope of the invention, and applicant intends to be bound only by the claims appended hereto.

What is claimed is:

1. A disc for use in a bottom up beverage cup filling process, the disc comprising:
a magnetic substrate;
an adhesive on the substrate;
an indicia ink oriented on the substrate held thereon by said adhesive;
said ink being FDA-compliant for use in contact with liquid for human consumption.

2. A disc as in claim 1 wherein said indicia includes one or more inks defining said indicia.

3. A laminate comprising a magnetic disc, said laminate comprising:
a carrier web;
a release coat on said web;
indicia ink carried by said web;
an adhesive on said release coat and said ink;
a magnetic substrate;
said adhesive holding such ink on said magnetic substrate.

4. A laminate as in claim 3 wherein the carrier web is a clear film.

5. A laminate as in claim 3 wherein the indicia ink is variable.

6. A laminate as in claim 5 including a scratch-off patch disposed over said variable indicia ink.

7. A process for making a magnetic disc comprising a magnetic substrate carrying indicia thereon, the process comprising the steps of:
applying a laminate, comprising a release coat on a carrier web, indicia defining ink on said release coat, and an adhesive layer disposed over said release coat and said ink, to a magnetic substrate;
removing said carrier web; and
cutting said laminate and substrate together to form said magnetic disc.

8. A process as in claim 7 wherein said substrate is two-sided and includes applying another laminate of a second carrier web, a release coat, ink and adhesive to another side of said substrate and removing said second carrier web from said other side of said substrate prior to said cutting step.

9. An indicia bearing magnetic member comprising:
a magnetic substrate;
indicia comprising at least one ink color.

10. A process for forming a magnetic member bearing indicia comprising the steps of:
applying multiple color indicia onto a magnetic substrate by transferring said ink indicia from a carrier web onto said substrate and removing said carrier web from said indicia and said substrate.

11. A process for applying indicia to a substrate and comprising:
applying a laminate to a substrate wherein the laminate comprises a release coat on a carrier web, indicia on said release coat, and an adhesive disposed over said release coat and indicia;
removing said carrier web; and
cutting remaining components of said laminate and said substrate together to form an indicia carrying element.

12. A composite for application to a magnetic element for use in sealing a bottom hole in a beverage cup and including:
an over laminate;
an adhesive on said underside of said over laminate ink indicia on said adhesive
a base film;
an adhesive on an underside of said base film; and
a release liner on said adhesive.

13. A composite as in claim 12 wherein said release liner is removed and said composite is applied to a magnetic substrate.

14. A composite as in claim 12 further including a pattern tactile coating on the adhesive on the underside of said over laminate, said ink indicia being disposed on an underside of said pattern tactile coating.

15. A composite for application to a magnetic element for use in sealing bottom hole in a beverage cup and including:
an over laminate;
ink indicia on an underside of said over laminate;
a peel away member on said underside over said ink;
a second over laminate;
ink indicia on an underside of said second over laminate;
an adhesive layer on said second over laminate and indicia;
a base film;
an adhesive on said base film; and
a release liner on said adhesive.

16. A composite as in claim 15 wherein said release liner is removed and said composite is adhered to a magnetic substrate.

17. A composite as in claim 15 wherein said peel away member is a coating.

18. A composite as in claim 15 wherein said peel away element is a coupon.

19. A composite for application to a substrate and including:
a base film;
ink indicia on an underside of said film; and
a flexible magnetic receptive coating on an underside of said base film.

20. A composite as in claim 19 further including:
an over laminate;
an adhesive on an underside of said over laminate;
ink indicia on said adhesive opposite said over laminate;
said over laminate adhesive and indicia thereon disposed on an upper surface of said base film.

21. A composite as in claim 20 wherein said over laminate is clear.

22. A composite as in claim 21 wherein said base film is opaque.

23. A composite as in claim 19 wherein said base film is clear.

24. A composite for application to a substrate and including:
a lens layer;
an adhesive or an underside of said lens layer;
ink indicia on said adhesive opposite said lens;
an opaque base film on said adhesive and indicia;
a flexible magnet receptive coating on said base film opposite said adhesive and indicia.

25. A composite for application to a substrate and including:
a lens layer;
an adhesive on an underside of said lens layer;
ink indicia on said adhesive opposite said lens layer;
an opaque base film on said adhesive and said indicia;
an adhesive on an underside of said base film; and
a release liner over said adhesive in said base film.

26. A composite as in claim 25 wherein said release liner is removed and said composite is adhered to a flexible magnet base member.
